(19) United States
(12) Patent Application Publication
(10) Pub. No.: US 2026/0124926 A1
(43) Pub. Date: May 7, 2026

(54) BATTERY ELECTRIC VEHICLE

(71) Applicant: TOYOTA JIDOSHA KABUSHIKI KAISHA, Toyota-shi (JP)

(72) Inventor: Kazuki FUJII, Hadano-shi (JP)

(73) Assignee: TOYOTA JIDOSHA KABUSHIKI KAISHA, Toyota-shi (JP)

(21) Appl. No.: 19/241,843

(22) Filed: Jun. 18, 2025

(30) Foreign Application Priority Data
Nov. 7, 2024 (JP) 2024-194994

(51) Int. Cl. B60L 15/20; B60L 50/60

(52) U.S. Cl. CPC B60L 15/20; B60L 50/60; B60L 2210/42; B60L 2240/12; B60L 2240/421; B60L 2240/423; B60L 2240/48; B60L 2250/28

(57) ABSTRACT

A battery electric vehicle includes one or more processors that control an output of an electric motor and a gear stage of a transmission. When the battery electric vehicle is in an on-demand mode, the one or more processors acquire a maximum target drive force that is a maximum value of a target drive force acquirable at a current vehicle speed of the battery electric vehicle and a maximum realizable drive force that is a maximum value of a drive force that can be output by the battery electric vehicle at a current vehicle speed of the battery electric vehicle and a current gear stage of the transmission. When the maximum target drive force is greater than the maximum realizable drive force, the one or more processors shift the gear stage of the transmission down to a specified gear stage at a specified timing.

### CROSS-REFERENCE TO RELATED APPLICATION

This application claims priority to Japanese Patent Application No. 2024-194994 filed on Nov. 7, 2024. The disclosure of the above-identified application, including the specification, drawings, and claims, is incorporated by reference herein in its entirety.

### BACKGROUND

### 1. Technical Field

The present disclosure relates to a battery electric vehicle including an electric motor as a drive source. The present disclosure relates in particular to a battery electric vehicle including a transmission that changes an output of an electric motor depending on a gear stage and transmits the changed output to drive wheels.

### 2. Description of Related Art

An electric motor can be controlled to output a desired motor torque by controlling a voltage or a magnetic field to be applied. By using this, a technique for reproducing various driving sensations in a battery electric vehicle by appropriately controlling an electric motor of the battery electric vehicle has been considered.

As one of elements that characterize the driving sensation, there is a sense of acceleration of a driver to a driving operation. The sense of acceleration is a major point when the driver feels fun in driving. In particular, a preference for the sense of acceleration is different for each driver. In addition, the driver may want to enjoy a sense of acceleration of various mobilities depending on a mood of the driver.

The inventors of the present disclosure use a plurality of models that models a plurality of virtual mobilities. The inventors of the present disclosure are considering an “on-demand mode” in which a sense of acceleration of the virtual mobilities is simulated in one battery electric vehicle. In the on-demand mode, control of the electric motor is performed to reproduce acceleration characteristics when a virtual mobility selected from among the virtual mobilities is driven, in the battery electric vehicle.

In the related art, a battery electric vehicle including a transmission has been considered. For example, Japanese Unexamined Patent Application Publication No. 2019-178741 (JP 2019-178741 A) discloses a technique for improving driving performance by reducing a gear-shifting time with respect to the battery electric vehicle including the transmission. By providing the battery electric vehicle with the transmission, power performance of the battery electric vehicle can be improved.

In addition, there is Japanese Unexamined Patent Application Publication No. 2018-166386 (JP 2018-166386 A) as a literature illustrating a technical level in this technical field.

### SUMMARY

A case where the battery electric vehicle including the transmission travels in the on-demand mode is considered. The battery electric vehicle in the on-demand mode is controlled to reproduce the acceleration characteristics of the virtual mobility for the driving operation of the driver. Meanwhile, the transmission is controlled in accordance with a predetermined shift schedule in the battery electric vehicle. In particular, in the battery electric vehicle and the virtual mobility, a configuration of a powertrain is usually different. Therefore, a problem is that reproducibility of the acceleration characteristics of the virtual mobility deteriorates because shift down of a gear stage that does not appear in an operation of the virtual mobility occurs depending on the driving operation of the driver. Examples of such a case include a case where the driver performs kick down of an accelerator pedal to suddenly accelerate the battery electric vehicle while the battery electric vehicle is executing steady traveling at a medium speed to a high speed.

The present disclosure has been made in consideration of the problem. One object of the present disclosure is to provide a technique capable of improving reproducibility of acceleration characteristics of a virtual mobility in a battery electric vehicle including a transmission.

One aspect of the present disclosure relates to a battery electric vehicle including an electric motor as a drive source. The battery electric vehicle includes a driving operation member used for driving, a transmission, one or more storage devices, and one or more processors. The transmission changes an output of the electric motor depending on a gear stage and transmits the changed output to drive wheels of the battery electric vehicle. The one or more storage devices manage a plurality of on-demand models that models a plurality of virtual mobilities with different driving environment characteristics for a driving operation of a driver. The one or more processors control the output of the electric motor and the gear stage of the transmission. When the battery electric vehicle is in an on-demand mode, the one or more processors
acquire, from the one or more storage devices, a target on-demand model corresponding to a target virtual mobility selected from among the virtual mobilities,
calculate, based on an operation state of the driving operation member and a traveling state of the battery electric vehicle, using the target on-demand model, virtual acceleration of the target virtual mobility for the driving operation of the driver,
calculate a target drive force of the battery electric vehicle for setting acceleration of the battery electric vehicle to be the virtual acceleration, and
control the output of the electric motor such that the target drive force is given to the battery electric vehicle.

In addition, when the battery electric vehicle is in the on-demand mode, the one or more processors
acquire a maximum target drive force that is a maximum value of the target drive force acquirable at a current vehicle speed of the battery electric vehicle, and
acquire a maximum realizable drive force that is a maximum value of a drive force outputtable by the battery electric vehicle at the current vehicle speed of the battery electric vehicle and a current gear stage of the transmission, and
shift down the gear stage of the transmission to a specified gear stage at a specified timing when the maximum target drive force is greater than the maximum realizable drive force.

According to the present disclosure, when the maximum target drive force is greater than the maximum realizable drive force, the gear stage of the transmission is shifted down to the specified gear stage at the specified timing. As a result, it is possible to inhibit the shift down of the gear stage that does not appear in an operation of the target virtual mobility, by the driving operation of the driver. As a result, reproducibility of acceleration characteristics of the target virtual mobility can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a battery electric vehicle according to an embodiment;

FIG. 2 is a tree diagram showing an example of a selection input that is received by an HMI regarding a control mode of a battery electric vehicle according to the embodiment;

FIG. 3 is a diagram showing an example of a functional configuration of a control device that functions as a drive control device;

FIG. 4 is a diagram showing an example of a shift schedule;

FIG. 5 is a diagram showing an example of acceleration characteristics of target virtual mobility reproduced by the battery electric vehicle;

FIG. 6 is a diagram showing an example of a functional configuration of the on-demand mode calculation unit;

FIG. 7 is a diagram showing an example of a case in which reproducibility of acceleration characteristics of the target virtual mobility deteriorates;

FIG. 8 is a flowchart showing a processing flow of processing executed by an on-demand target gear stage calculation unit according to the embodiment;

FIG. 9 is a diagram showing an embodiment of the drive control device according to the embodiment;

FIG. 10 is a diagram showing an example of a configuration of an on-demand model;

FIG. 11 is a flowchart showing a processing flow of processing executed by the on-demand target drive force calculation unit according to Modification; and

FIG. 12 is a diagram showing an example of a functional configuration of a control device that functions as an in-vehicle apparatus control device.

### DETAILED DESCRIPTION OF EMBODIMENTS

Hereinafter, embodiments of the present disclosure will be described with reference to drawings. In each figure, the same reference numeral is assigned to the same or corresponding part and a description thereof is simplified or omitted.

### 1. Configuration of Power System of Battery Electric Vehicle

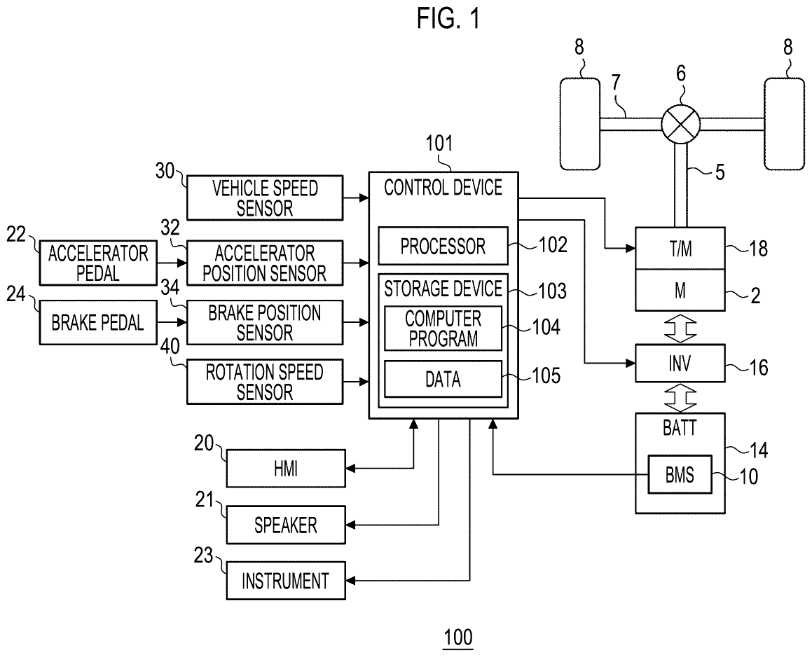

FIG. 1 is a diagram schematically showing a configuration of a battery electric vehicle 100 according to an embodiment of the present disclosure. First, a configuration of a power system of a battery electric vehicle 100 will be described with reference to FIG. 1.

The battery electric vehicle 100 includes an electric motor (M) 2 as a drive source for traveling. The electric motor 2 is, for example, a three-phase alternating current motor. An inverter (INV) 16 is attached to the electric motor 2. An output shaft of the electric motor 2 is connected to a transmission (T/M) 18. A speed reducer may be provided between the output shaft of the electric motor 2 and the transmission 18. The transmission 18 is connected to the differential gear 6 by the propeller shaft 5. The differential gear 6 is connected to left and right drive wheels 8 by left and right drive shafts 7. The drive wheels 8 may be front wheels or rear wheels. With these configurations, the transmission 18 has a function of changing the output of the electric motor 2 according to the gear stage and transmitting the changed output to the drive wheels 8 of the battery electric vehicle 100. The switching of the gear stage of the transmission 18 is controlled by a control device 101 described below.

The inverter 16, the electric motor 2, the speed reducer, and the differential gear 6 may be integrally configured as an e-axle. In this case, the battery electric vehicle 100 does not include the propeller shaft 5, and the e-axle is connected to the drive shaft 7. In addition, as still another Modification, the configuration of the battery electric vehicle 100 may be four-wheel drive. For example, the battery electric vehicle 100 may include a transfer connected to an output shaft of the transmission 18 and be configured to distribute the output of the transmission 18 to front wheels and rear wheels by the transfer.

The inverter 16 is connected to a battery (BATT) 14. The inverter 16 is, for example, a voltage type inverter, and controls a motor torque of the electric motor 2 by PWM control. That is, the battery electric vehicle 100 is a battery electric vehicle (BEV) that travels by the electric energy stored in the battery 14 as a drive source of the electric motor 2.

### 2. Configuration of Control System of Battery Electric Vehicle

Subsequently, the configuration of the control system of the battery electric vehicle 100 will be described with reference to FIG. 1.

The battery electric vehicle 100 includes a vehicle speed sensor 30. The vehicle speed sensor 30 outputs a signal indicating the vehicle speed of the battery electric vehicle 100. At least one of wheel speed sensors (not shown) provided on each of left and right front wheels and left and right rear wheels is used as the vehicle speed sensor 30.

In addition, the battery electric vehicle 100 further includes an accelerator position sensor 32. The accelerator position sensor 32 is provided in the accelerator pedal 22 and outputs a signal indicating an operation state of the accelerator pedal 22. The operation state of the accelerator pedal 22 typically includes an accelerator operation amount and an accelerator operation speed. The battery electric vehicle 100 may include a lever-type accelerator operation device or a dial-type accelerator operation device that is operated by hand instead of the accelerator pedal 22. Also in this case, the accelerator position sensor 32 outputs a signal indicating the operation state of these accelerator operation devices.

In addition, the battery electric vehicle 100 further includes a brake position sensor 34. The brake position sensor 34 is provided on the brake pedal 24 and outputs a signal indicating an operation state of the brake pedal 24. The operation state of the brake pedal 24 typically includes a brake operation amount or a brake operation speed.

The accelerator pedal 22 and the brake pedal 24 are each one of driving operation members used for driving the battery electric vehicle 100. In addition, the battery electric vehicle 100 may include various driving operation members, such as a steering wheel for driving related to steering.

In addition, the battery electric vehicle 100 further includes a rotation speed sensor 40. The rotation speed sensor 40 is provided in the electric motor 2, and outputs a signal indicating a rotation speed of the electric motor 2.

In addition, the battery electric vehicle 100 includes a battery management system (BMS) 10. The battery management system 10 is a device that monitors a cell voltage, current, temperature, and the like of the battery 14. In particular, the battery management system 10 has a function of estimating a state of charge (SOC) of the battery 14.

In addition, the battery electric vehicle 100 includes a human machine interface (HMI) 20. The HMI 20 presents various types of information to the driver by display or sound, and also receives various types of inputs from the driver. The HMI 20 is composed of a display, a touch screen, a switch, a touch pad, a speaker phone, a microphone, and the like. The display is, for example, a multi-information display, a meter display, or a multimedia display. The switch is, for example, a steering switch, a multimedia switch, or a door switch. For example, the HMI 20 displays various pieces of information on the display and receives an input from the driver for the display content by a touch operation on the touch screen.

In addition, the battery electric vehicle 100 further includes a speaker 21. The speaker 21 includes a vehicle interior speaker that generates sound at least in the vehicle cabin of the battery electric vehicle 100. As another example, the speaker 21 may include a vehicle exterior speaker that generates sound outside the battery electric vehicle 100. The battery electric vehicle 100 may include both a vehicle interior speaker and a vehicle exterior speaker as the speaker 21. The speaker 21 may be configured as a part of the HMI 20. The output of the speaker 21 is controlled by a control device 101 described below.

In addition, the battery electric vehicle 100 further includes an instrument 23. The instrument 23 displays various kinds of information. Examples of the instrument 23 include a speedometer, an odometer, a tachometer, a trip meter, and a battery charge meter. The instrument 23 may be configured as a part of the HMI 22. The display of the instrument 23 is controlled by a control device 101 described below.

The battery electric vehicle 100 includes a control device 101. Various sensors and control target devices mounted on the battery electric vehicle 100 are connected to the control device 101 by an in-vehicle network, such as a controller area network (CAN). In addition to the vehicle speed sensor 30, the accelerator position sensor 32, the brake position sensor 34, and the rotation speed sensor 40, various sensors may be mounted on the battery electric vehicle 100. In addition, various sensors may be connected to the control device 101 via an in-vehicle network.

The control device 101 generates a control signal for various controls of the battery electric vehicle 100 based on signals acquired from the respective sensors. The control device 101 is typically an electronic control unit (ECU). The control device 101 may be a combination of a plurality of ECUs. The control device 101 includes one or more processors 102 (hereinafter, simply referred to as processor 102) and one or more storage devices 103 (hereinafter, simply referred to as storage device 103).

The processor 102 executes various types of processing. The processor 102 may be, for example, a general-purpose processor, a specific-purpose processor, a central processing unit (CPU), a graphics processing unit (GPU), an application specific integrated circuit (ASIC), a field-programmable gate array (FPGA), an integrated circuit, or a circuit in the related art. The processor 102 is configured by one or a plurality of combinations thereof. The processor 102 can also be referred to as processing circuitry. The processing circuitry is hardware programmed to realize the function of the control device 101, or hardware that executes the function of the control device 101.

The storage device 103 stores various types of information needed to execute the processing of the processor 102. The storage device 103 is configured of a recording medium, such as a random access memory (RAM), a read only memory (ROM), a solid state drive (SSD), or a hard disk drive (HDD). The storage device 103 stores a computer program 104 that can be executed by the processor 102 and various data 105. The computer program 104 is composed of a plurality of instruction codes that describe processing to be executed by the processor 102. The computer program 104 is recorded on a computer-readable recording medium. The processor 102 that executes the computer program 104 and the storage device 103 cooperate with each other to realize the function of the control device 101.

The control device 101 according to the present embodiment has at least two control modes, a normal mode and an on-demand mode, for the control of the battery electric vehicle 100. The control of the battery electric vehicle 100 to be executed by the control device 101 is changed according to the selected control mode. Hereinafter, a control mode of the battery electric vehicle 100 will be described.

### 3. Control Mode of Battery Electric Vehicle

As described above, there are at least two control modes for the battery electric vehicle 100: a normal mode and an on-demand mode. The normal mode is a control mode in which the control of the battery electric vehicle 100 is performed such that the battery electric vehicle 100 operates as a normal BEV. On the other hand, the on-demand mode is a control mode in which the driving environment characteristics of the selected virtual mobility (hereinafter, referred to as “target virtual mobility”) from among a plurality of virtual mobilities are reproduced in the battery electric vehicle 100. There are times when the battery electric vehicle 100 is in the on-demand mode. In this case, the control device 101 controls the battery electric vehicle 100 such that the driver can obtain the driving environment as if the driver is driving the target virtual mobility. In particular, the driving environment characteristic of the target virtual mobility reproduced in the on-demand mode includes the acceleration characteristic of the virtual mobility with respect to the driving operation of the driver. Details of each control of the battery electric vehicle 100 in each of the normal mode and the on-demand mode will be described below.

In the on-demand mode, the plurality of virtual mobilities include various mobilities having differences in driving environment characteristics for a driving operation of the driver. The “mobility” is a general term for a vehicle that can be driven by the driver operating a driving operation member. The virtual mobility is typically a vehicle having a driving environment characteristic different from the battery electric vehicle 100. Note that the virtual mobility may be various forms of vehicles, such as a motorbike or a train. Each of the virtual mobilities may be assumed to be real mobility or may be assumed to be mobility that does not exist in reality. The difference in the acceleration characteristic as the driving environment characteristic is generally due to a difference in the configuration of the powertrain from the drive source to the drive wheels or a difference in the control method of the powertrain. Therefore, it can be considered that the plurality of virtual mobilities include various mobilities in which at least some elements of the configuration or the control method related to the powertrain are different. In the following, for the sake of simplicity of description, each of the virtual mobilities is assumed to be a vehicle.

The driver operates the HMI 20 to select the control mode. The HMI 20 is configured to receive a selection input of the control mode from the driver. Further, the HMI 20 is configured to receive a selection input of the target virtual mobility from the driver with respect to the on-demand mode.

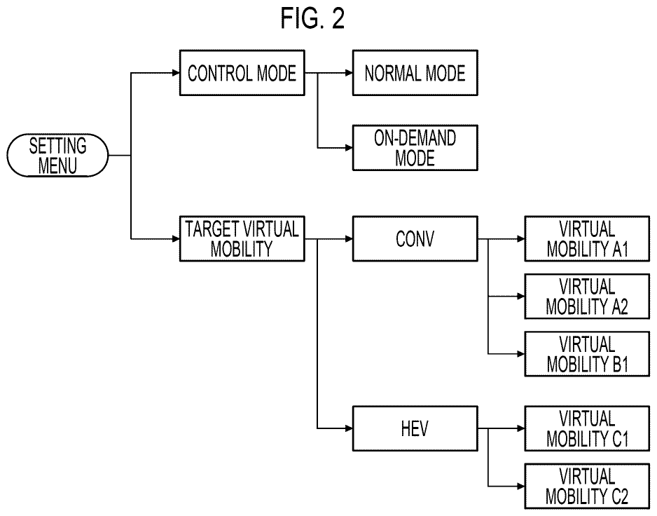

FIG. 2 is a tree diagram showing an example of the selection input received by the HMI 20. For example, the HMI 20 receives the selection input from the driver as follows in accordance with the tree shown in FIG. 2, via the display on the display or the touch screen.

First, the HMI 20 displays a setting menu screen on the display or the touch screen in response to the operation of the driver. The initial screen of the setting menu screen displays an option “control mode” and an option “target virtual mobility”. The option “control mode” is to receive the selection input of the control mode from the driver. The option “target virtual mobility” is an option for receiving a selection input of the target virtual mobility from the driver.

When the option “control mode” is selected, next, the setting menu screen displays the option “normal mode” and the option “on-demand mode”. When the option “normal mode” is selected, the HMI 20 determines that the control mode of the battery electric vehicle 100 is the normal mode. When the option “on-demand mode” is selected, the HMI 20 determines that the control mode of the battery electric vehicle 100 is the on-demand mode. In this manner, the HMI 20 receives the selection input of the control mode from the driver.

On the other hand, when the option “target virtual mobility” is selected, the options “CONV” and “HEV” are displayed on the setting menu screen. The option “CONV” and the option “HEV” respectively indicate a plurality of classifications of the virtual mobility that can be selected in the on-demand mode. CONV is a classification indicating an engine vehicle equipped with a conventional internal combustion engine (conventional vehicle). The HEV is a classification indicating a hybrid electric vehicle (hybrid electronic vehicle). When the option “CONV” is selected, next, the options “virtual mobility A1”, “virtual mobility A2”, and “virtual mobility B1” are displayed on the setting menu screen. The virtual mobility A1, the virtual mobility A2, and the virtual mobility B1 are virtual mobilities classified into the CONV among the plurality of selectable virtual mobilities. Similarly, when the option “HEV” is selected, the options “virtual mobility C1” and “virtual mobility C2” are then displayed on the setting menu screen. The virtual mobility C1 and the virtual mobility C2 are virtual mobilities classified into the HEV among the plurality of selectable virtual mobilities. In a case where any one of the options is selected, the HMI 20 determines that the selected virtual mobility is the target virtual mobility. For example, in a case where the option “virtual mobility A2” is selected, the HMI 20 determines that the virtual mobility A2 is the target virtual mobility. In this way, the HMI 20 receives the selection input of the target virtual mobility from the driver.

The plurality of classifications of the virtual mobility in the above description is an example, and the options related to the classification may be appropriately changed. For example, the options related to the classification may further include options indicating a plug-in hybrid electric vehicle (PHEV) or a fuel cell electric vehicle (FCEV). In addition, for example, the options related to the classification may indicate other classifications, such as a classification related to the type of the mounted drive source (for example, an in-line four-cylinder turbocharged engine, a flat six-cylinder engine, a V12 engine, a battery, and a fuel cell). Alternatively, when the option “on-demand mode” is selected, the setting menu screen may display the options related to the virtual mobility without displaying the options related to the classification.

In addition, the name displayed on the setting menu screen for each of the options may be appropriately given in consideration of the ease of understanding of the driver. For example, in the option related to the virtual mobility, the displayed name may be a specific name that is easy for the driver to image the virtual mobility, such as a vehicle model or a product name.

As described above, the driver can select the control mode by operating the HMI 20. The control device 101 controls the battery electric vehicle 100 in response to the selected control mode.

The control device 101 according to the present embodiment functions as a drive control device that performs drive control of the battery electric vehicle 100 by controlling the output of the electric motor 2 and the gear stage of the transmission 18 according to the driving operation of the driver. Specifically, the control device 101 functions as a drive control device by the processor 102 executing the computer program 104 for drive control stored in the storage device 103. Hereinafter, the control of the battery electric vehicle 100 by the drive control device will be described.

### 4. Drive Control Device

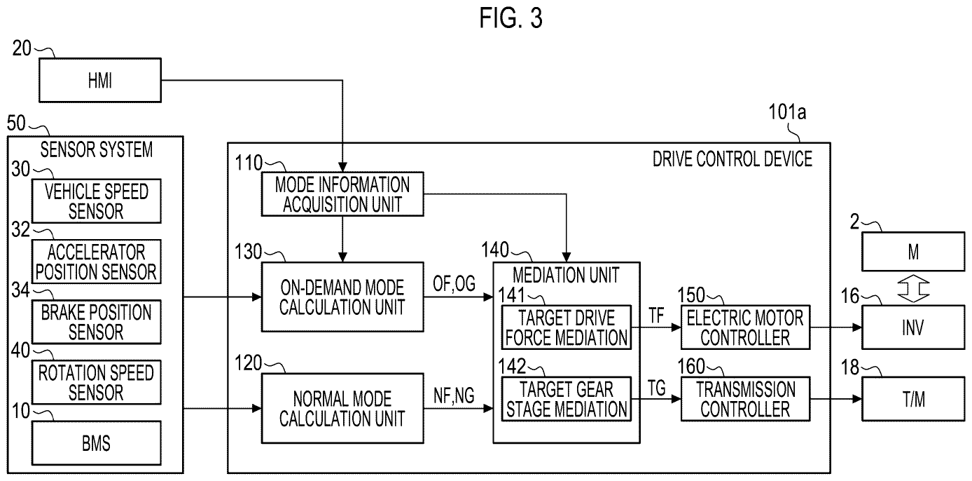

FIG. 3 is a diagram showing an example of a functional configuration of the drive control device 101a. The drive control device 101a calculates the target drive force TF and the target gear stage TG of the battery electric vehicle 100 according to the driving operation of the driver. The drive control device 101a controls the electric motor 2 and the transmission 18 to realize the calculated target drive force TF and the target gear stage TG.

The drive control device 101a receives signals from the HMI 20 and the sensor system 50. The sensor system 50 includes a vehicle speed sensor 30, an accelerator position sensor 32, a brake position sensor 34, a rotation speed sensor 40, and the battery management system 10. The sensor system 50 may further include a steering angle sensor for detecting a steering angle of the steering wheel and a yaw rate sensor for detecting a yaw rate of the battery electric vehicle 100. The sensor system 50 may further include an inertial measurement unit (IMU) for detecting the posture of the battery electric vehicle 100, a sensor (for example, a camera, a radar, or LiDAR) for detecting the surrounding environment of the battery electric vehicle 100, and the like.

The signal input to the drive control device 101a from the HMI 20 includes a signal indicating the control mode selected by the driver and a signal indicating the target virtual mobility selected by the driver. The signal input to the drive control device 101a from the sensor system 50 includes a signal indicating the vehicle speed of the battery electric vehicle 100 and a signal indicating the operation state of the accelerator pedal 22. In addition, the signal input to the drive control device 101a from the sensor system 50 includes a signal indicating the operation state of the brake pedal 24, a signal indicating the rotation speed of the electric motor 2, and a signal indicating the state of charge (SOC) of the battery 14.

The drive control device 101a includes a mode information acquisition unit 110, a normal mode calculation unit 120, an on-demand mode calculation unit 130, a mediation unit 140, an electric motor controller 150, and a transmission controller 160 as functional blocks. These functional blocks are realized by the cooperation of the processor 102 that executes the computer program 104 and the storage device 103.

The mode information acquisition unit 110 receives the signal from the HMI 20 and acquires information regarding which one of the normal mode and the on-demand mode is selected. In addition, the mode information acquisition unit 110 acquires information on the target virtual mobility selected from among the plurality of virtual mobilities. The mode information acquisition unit 110 transmits the information on the selected control mode to the mediation unit 140. In addition, the mode information acquisition unit 110 transmits the information on the selected target virtual mobility to the on-demand mode calculation unit 130.

The normal mode calculation unit 120 calculates a target drive force NF (hereinafter, referred to as “normal target drive force NF”) and a target gear stage NG (hereinafter, referred to as “normal target gear stage NG”) as a normal mode based on a signal from the sensor system 50. The normal target drive force NF and the normal target gear stage NG are the target drive force and the target gear stage for operating the battery electric vehicle 100 as a normal BEV, respectively.

For example, the normal mode calculation unit 120 calculates the normal target drive force NF using the map. In this case, the map can be configured to provide the normal target drive force NF with the operation state of the driving operation member and the traveling state of the battery electric vehicle 100 as parameters. For example, the map provides the normal target drive force NF with the accelerator operation amount of the accelerator pedal 22 and the rotation speed of the electric motor 2 as parameters. Further, the map may be configured to provide the normal target drive force NF with the brake operation amount of the brake pedal 24 or the SOC of the battery 14 as a parameter.

In addition, the normal mode calculation unit 120 calculates the normal target gear stage NG, for example, according to a predetermined shift schedule. The shift schedule is configured to set the use range of each of the gear stages with respect to the current vehicle speed and the target drive force of the battery electric vehicle 100, for example. The shift schedule may be given by a gear shift diagram. The shift schedule is appropriately configured in consideration of fuel efficiency, maintenance performance, and the like of the battery electric vehicle 100. The shift schedule may be stored in the storage device 103 in advance as data 105.

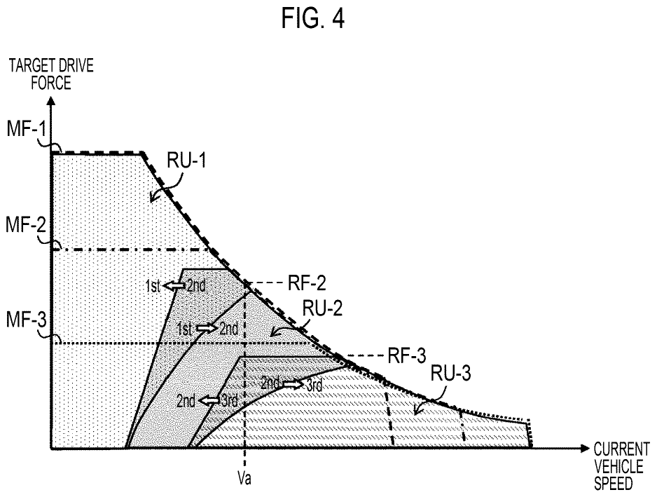

FIG. 4 is a diagram showing an example of a shift schedule. Further, FIG. 4 shows an example of output characteristics MF indicating a drive force (acceleration) that can be output by the battery electric vehicle 100. The output characteristic MF changes according to the gear stage of the transmission 18. Specifically, the larger the gear ratio of the transmission 18 is, the larger the maximum drive force of the battery electric vehicle 100 is. On the other hand, the larger the gear ratio of the transmission 18 is, the smaller the maximum vehicle speed of the battery electric vehicle 100 is. In FIG. 4, in a case where the transmission 18 has three gear stages (1st, 2nd, 3rd), three output characteristics MF-1 (broken line), MF-2 (one-dot chain line), MF-3 (dotted line) are shown for each of the gear stages. The output characteristics MF-1, MF-2, MF-3 have larger gear ratios for the gear stages in this order. That is, the output characteristics MF-1, MF-2, MF-3 are the output characteristics MF when the gear stages of the transmission 18 are 1st, 2nd, and 3rd, respectively.

Further, in FIG. 4, a use range RU of each of the gear stages determined by the shift schedule is shown. The use range RU-1 is the use range RU of the 1st gear stage. In addition, the use range RU-2 is a use range RU of the 2nd gear stage. In addition, the use range RU-3 is a use range RU of a 3rd gear stage. As shown in FIG. 4, the gear stages to be used for the current vehicle speed and the target drive force of the battery electric vehicle 100 can be specified from the use range RU determined by the shift schedule. When the use range RU is crossed is the gear shift timing in particular. The normal target gear stage calculation unit 123 calculates the gear stage specified by the current vehicle speed of the battery electric vehicle 100 and the normal target drive force NF as the normal target gear stage NG, according to the shift schedule as shown in FIG. 4.

Referring to FIG. 3 again. The normal mode calculation unit 120 transmits the calculated normal target drive force NF and the normal target gear stage NG to the mediation unit 140. The processing related to the normal mode calculation unit 120 in the present embodiment may be appropriately changed. The processing related to the normal mode calculation unit 120 can adopt a known suitable method used in a normal BEV in the related art to calculate the target drive force or the target gear stage.

The on-demand mode calculation unit 130 acquires the information on the target virtual mobility from the mode information acquisition unit 110. The on-demand mode calculation unit 130 calculates the target drive force OF and the target gear stage OG as the on-demand mode based on the signal from the sensor system 50. The target drive force OF as the on-demand mode is referred to as an “on-demand target drive force OF” hereinafter. In addition, the target gear stage OG is referred to as an “on-demand target gear stage OG” hereinafter. The on-demand target drive force OF is a target drive force for reproducing the acceleration characteristic of the virtual mobility with respect to the driving operation of the driver in the battery electric vehicle 100. Details of the processing executed by the on-demand mode calculation unit 130 will be described below. The on-demand mode calculation unit 130 transmits the calculated on-demand target drive force OF and the on-demand target gear stage OG to the mediation unit 140.

The mediation unit 140 mediates the target drive force TF used for controlling the electric motor 2 and the target gear stage TG used for controlling the transmission 18 according to the selected control mode. The mediation unit 140 executes processing 141 of mediating the target drive force TF and processing 142 of mediating the target gear stage TG.

In the processing 141, the mediation unit 140 transmits the on-demand target drive force OF calculated by the on-demand mode calculation unit 130 to the electric motor controller 150 while the on-demand mode is selected. In addition, the mediation unit 140 transmits the normal target drive force NF calculated by the normal mode calculation unit 120 to the electric motor controller 150 while the normal mode is selected. In the processing 141, the mediation unit 140 may gradually change the target drive force TF to be transmitted to the electric motor controller 150 in a case where the control mode is switched. For example, in a case where the control mode is switched from the normal mode to the on-demand mode, the mediation unit 140 may set a value that is gradually changed from the normal target drive force NF to the on-demand target drive force OF within a certain switching period as the target drive force TF.

In the processing 142, the mediation unit 140 transmits the on-demand target gear stage OG calculated by the on-demand mode calculation unit 130 to the transmission controller 160 while the on-demand mode is selected. In addition, the mediation unit 140 transmits the normal target gear stage NG calculated by the normal mode calculation unit 120 to the transmission controller 160 while the normal mode is selected.

The drive control device 101a may be configured not to execute the processing related to the normal mode calculation unit 120 while the on-demand mode is selected. Similarly, the drive control device 101a may be configured not to execute the processing related to the on-demand mode calculation unit 130 while the normal mode is selected. With the configuration as described above, it is possible to reduce the processing load of the drive control device 101a in each of the control modes.

The electric motor controller 150 controls the electric motor 2 to realize the target drive force TF transmitted from the mediation unit 140. More specifically, the electric motor controller 150 generates a control signal for the inverter 16 in response to the target drive force TF. The electric motor controller 150 changes the motor torque output by the electric motor 2 via the PWM control by the inverter 16.

The transmission controller 160 controls the transmission 18 to realize the target gear stage TG transmitted from the mediation unit 140. More specifically, the transmission controller 160 generates a control signal for the transmission 18 according to the target gear stage TG. The transmission 18 changes a gear stage in response to a control signal from the transmission controller 160.

In this way, the drive control device 101a calculates the target drive force TF and the target gear stage TG of the battery electric vehicle 100 according to the control mode. The drive control device 101a controls the electric motor 2 and the transmission 18 to realize the calculated target drive force TF and the target gear stage TG. In particular, with the drive control device 101a, the electric motor 2 is controlled to reproduce the acceleration characteristics of the target virtual mobility in the battery electric vehicle 100 while the on-demand mode is selected. On the other hand, the acceleration characteristic of the battery electric vehicle 100 while the normal mode is selected is the acceleration characteristic of the normal BEV.

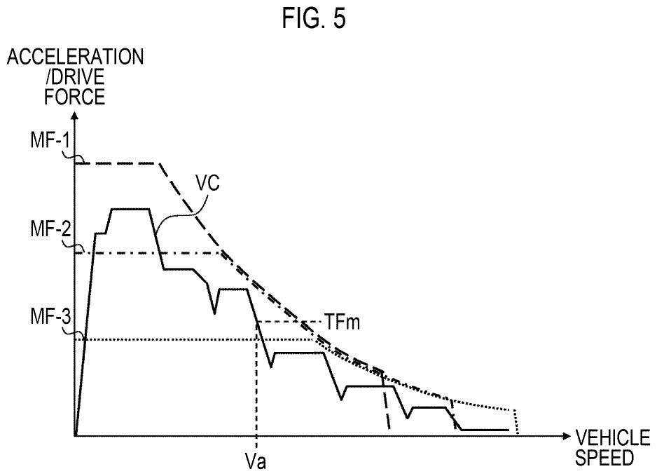

FIG. 5 is a diagram showing an example of acceleration characteristic VC of the target virtual mobility reproduced by the battery electric vehicle 100. Further, FIG. 5 shows an example of the output characteristic MF of the battery electric vehicle 100 in a case where the transmission 18 has three gear stages (1st, 2nd, 3rd) as in the case shown in FIG. 4, as a comparison. Each of the output characteristics MF can also be considered as the acceleration characteristics of the battery electric vehicle 100 while the normal mode is selected.

The acceleration characteristic of the battery electric vehicle 100 while the on-demand mode is selected reproduces the acceleration characteristic VC of the target virtual mobility. Therefore, the acceleration characteristic of the battery electric vehicle 100 while the on-demand mode is selected changes to various patterns according to the target virtual mobility by changing the target virtual mobility. As a result, the driver can enjoy various virtual mobility sense of accelerations in the battery electric vehicle 100 in the on-demand mode.

Hereinafter, the processing executed by the on-demand mode calculation unit 130 will be described in detail.

### 4.1. On-Demand Mode Calculation Unit

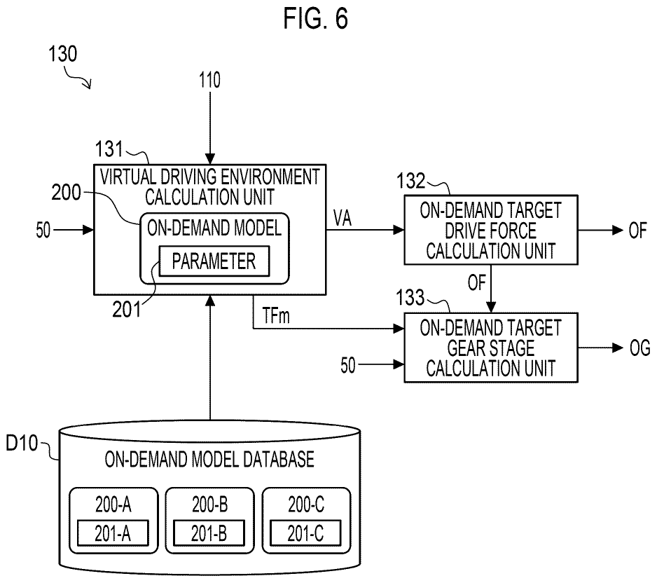

FIG. 6 is a diagram showing an example of a functional configuration of the on-demand mode calculation unit 130. The on-demand mode calculation unit 130 calculates the on-demand target drive force OF and the on-demand target gear stage OG. The on-demand mode calculation unit 130 includes a virtual driving environment calculation unit 131, an on-demand target drive force calculation unit 132, and an on-demand target gear stage calculation unit 133 as functional blocks. In addition, the on-demand mode calculation unit 130 is configured to be able to access the on-demand model database D10.

The on-demand model database D10 is a database that manages a plurality of on-demand models 200 modeling a plurality of virtual mobilities. The on-demand model database D10 may be stored in the storage device 103 as data 105. In addition, each of the on-demand models 200 managed by the on-demand model database D10 may be updated at any time. In addition, the on-demand model database D10 may be downloaded with a new on-demand model 200 at any time. In the example shown in FIG. 6, the on-demand model database D10 manages three on-demand models 200-A, 200-B, 200-C. Each of the on-demand models 200 is a model that simulates a driving environment of virtual mobility for a driving operation of the driver with an operation state of the driving operation member and a traveling state of the battery electric vehicle 100 as inputs. In particular, each of the on-demand models 200 is configured to be able to simulate the acceleration characteristics of the virtual mobility. That is, each of the on-demand models 200 is configured to be able to simulate at least the drive force given to the virtual mobility for the driving operation of the driver and the acceleration and deceleration operation of the virtual mobility by the action of the drive force. The simulation result of the acceleration and deceleration operation of the virtual mobility by each of the on-demand models 200 includes the virtual acceleration VA of the virtual mobility.

Typically, each of the on-demand models 200 includes a control model that simulates a control system related to a powertrain of the virtual mobility, and a plant model that simulates an acceleration and deceleration operation of the virtual mobility in response to a control signal from the control model. In this case, the plant model includes a model of a powertrain that operates based on a control signal from the control model, and a model for simulating the operation of virtual mobility due to the action of the virtual drive force of the powertrain model. An example of the configuration of the on-demand model 200 will be described below.

In addition, each of the on-demand models 200 has a parameter 201 related to the operation of the virtual mobility in the simulation. Examples of the parameter 201 include weight, wheel diameter, gear ratio, maximum torque of the drive source, drive torque responsiveness, and a shift schedule. The content of the parameter 201 may be different for each of the on-demand models 200. The on-demand model 200 represents one virtual mobility model by combining the on-demand model 200 with the setting value of the parameter 201. For example, each of the virtual mobilities represents a model of one virtual mobility by a combination of the on-demand model 200 and the setting value of the parameter 201 as shown in the following table. As shown in the following table, the same on-demand model 200 may correspond to different virtual mobilities. This is a case where the types of the powertrain systems are the same as each other and the virtual mobility of each of the powertrain systems can be represented by changing the setting value of the parameter 201, for example.

TABLE 1

| Virtual mobility | On-demand model | Parameter |
|---|---|---|
| Virtual mobility A1 | 200-A | Setting value A1 |
| Virtual mobility A2 | 200-A | Setting value A2 |
| Virtual mobility B1 | 200-B | Setting value B1 |
| Virtual mobility C1 | 200-C | Setting value C1 |
| Virtual mobility C2 | 200-C | Setting value C2 |

The virtual driving environment calculation unit 131 acquires the information on the target virtual mobility from the mode information acquisition unit 110. The virtual driving environment calculation unit 131 reads out the on-demand model 200 (target on-demand model) corresponding to the target virtual mobility by referring to the on-demand model database D10 from the acquired information. Further, the virtual driving environment calculation unit 131 sets the parameters 201 of the on-demand model 200 read out according to the target virtual mobility. For example, when the target virtual mobility is the “virtual mobility B1” in the table above, the virtual driving environment calculation unit 131 refers to the on-demand model database D10 to read out the on-demand model 200-B. The virtual driving environment calculation unit 131 sets the parameters 201-B of the on-demand model 200-B to the setting value B1.

The virtual driving environment calculation unit 131 uses the read-out target on-demand model to simulate the virtual driving environment of the target virtual mobility for the driving operation of the driver. More specifically, the virtual driving environment calculation unit 131 receives a signal from the sensor system 50. The virtual driving environment calculation unit 131 acquires information on an operation state of a driving operation member for use as an input to the target on-demand model and information on a traveling state of the battery electric vehicle 100. For example, the virtual driving environment calculation unit 131 acquires the accelerator operation amount of the accelerator pedal 22 and the vehicle speed of the battery electric vehicle 100. In addition, depending on the configuration of the target on-demand model, the virtual driving environment calculation unit 131 may acquire the accelerator operation speed of the accelerator pedal 22, the brake operation amount and the brake operation speed of the brake pedal 24. Further, the virtual driving environment calculation unit 131 may acquire information such as a steering angle of the steering wheel and the yaw rate of the battery electric vehicle 100. The virtual driving environment calculation unit 131 simulates the virtual driving environment of the target virtual mobility by inputting the acquired information to the target on-demand model. In particular, the virtual driving environment calculation unit 131 calculates the virtual acceleration VA of the target virtual mobility for the driving operation of the driver through the simulation of the virtual driving environment of the target virtual mobility. The virtual driving environment calculation unit 131 transmits the calculated virtual acceleration VA to the on-demand target drive force calculation unit 132.

In the present embodiment, the virtual driving environment calculation unit 131 further acquires a maximum value TFm of the on-demand target drive force OF that can be acquired at the current vehicle speed of the battery electric vehicle 100. A maximum value TFm of the on-demand target drive force OF is hereinafter referred to as a “maximum target drive force TFm”. The maximum target drive force TFm can be acquired from the acceleration characteristic VC of the target virtual mobility. For example, in FIG. 5, the maximum target drive force TFm of the battery electric vehicle 100 at the current vehicle speed Va is shown with respect to the acceleration characteristic VC of the target virtual mobility. The target virtual mobility acceleration characteristic VC is determined by the target on-demand model. Therefore, the virtual driving environment calculation unit 131 can determine the acceleration characteristic VC of the target virtual mobility when the target virtual mobility is determined. The virtual driving environment calculation unit 131 may manage the acceleration characteristic VC of each of the virtual mobilities in advance. Alternatively, each of the on-demand models 200 may be configured to output the acceleration characteristic VC. The virtual driving environment calculation unit 131 acquires the maximum target drive force TFm from the current vehicle speed Va of the battery electric vehicle 100 and the determined acceleration characteristic VC of the target virtual mobility. The virtual driving environment calculation unit 131 transmits the acquired maximum target drive force TFm to the on-demand target gear stage calculation unit 133.

When the virtual acceleration VA is acquired, the on-demand target drive force calculation unit 132 calculates the drive force for setting the acceleration of the battery electric vehicle 100 as the virtual acceleration VA as the on-demand target drive force OF. For example, the on-demand target drive force calculation unit 132 converts the virtual acceleration VA into the on-demand target drive force OF by using a simple inverse model of the battery electric vehicle 100 as shown in the following equation. In the following equation, m is the vehicle weight of the battery electric vehicle 100, and F_{load} is actual traveling resistance of the battery electric vehicle 100. The on-demand mode calculation unit 130 outputs the on-demand target drive force OF calculated by the on-demand target drive force calculation unit 132.

$$OF = m * VA - {F}_{load}$$

The on-demand target gear stage calculation unit 133 acquires various signals from the sensor system 50. In addition, the on-demand target gear stage calculation unit 133 acquires the maximum target drive force TFm from the virtual driving environment calculation unit 131. In addition, the on-demand target gear stage calculation unit 133 acquires the on-demand target drive force OF calculated by the on-demand target drive force calculation unit 132. The on-demand target gear stage calculation unit 133 calculates the on-demand target gear stage OG from the acquired information. The on-demand mode calculation unit 130 outputs the on-demand target gear stage OG calculated by the on-demand target gear stage calculation unit 133.

Here, a case where the on-demand target gear stage OG is calculated in the same manner as in the normal mode according to the predetermined shift schedule by the on-demand target gear stage calculation unit 133 will be considered. In this case, there is a possibility that the driving operation of the driver causes shift down of the gear stage that does not appear in the operation of the target virtual mobility. This is because the configuration of the powertrain is different between the battery electric vehicle 100 and the target virtual mobility in general. In particular, in the battery electric vehicle 100 and the target virtual mobility, the presence or absence of a transmission, the number of gear stages, and the gear ratio may be different. There is a risk of reproducibility of the acceleration characteristic VC of the target virtual mobility to deteriorate as a result when shift down of the gear stage that does not appear in the operation of the target virtual mobility occurs.

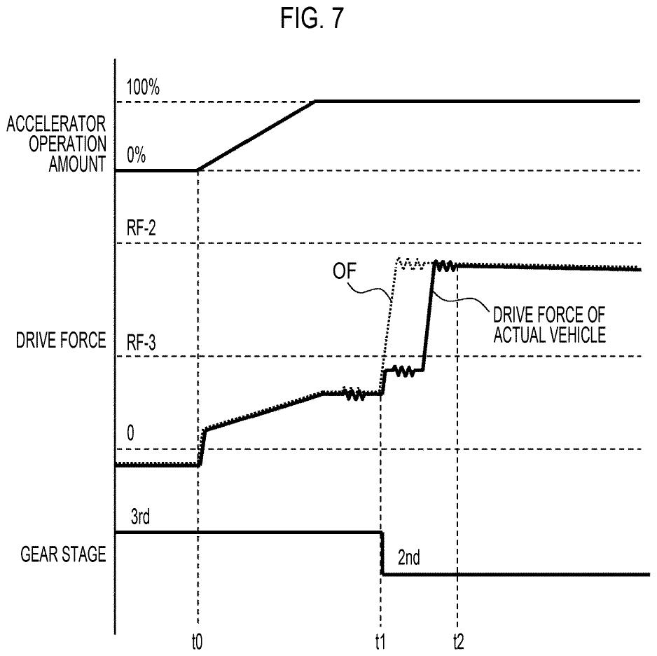

FIG. 7 is a diagram showing an example in which the reproducibility of the acceleration characteristic VC of the target virtual mobility deteriorates due to the occurrence of the shift down of the gear stage. In FIG. 7, the accelerator operation amount, the on-demand target drive force OF (dotted line), the drive force of the battery electric vehicle 100 (solid line), and the time change in the gear stage are shown. In the example shown in FIG. 7, the driver performs the kick down at time t0. As a result, the on-demand target drive force OF is greatly increased from time t1. With the increase in the on-demand target drive force OF, the shift down of the gear stage from the 3rd gear stage to the 2nd gear stage occurs at time t1. Here, RF-2 shown in FIG. 7 is a maximum value RF (hereinafter, referred to as “maximum realizable drive force RF”) of the drive force that can be output at the current vehicle speed Va of the battery electric vehicle 100 when the current gear stage of the transmission 18 is 2nd. In addition, the RF-3 is the maximum realizable drive force RF-3 when the current gear stage of the transmission 18 is 3rd. That is, the shift down at time t1 is caused by the on-demand target drive force OF that has increased from time t1 exceeding the maximum realizable drive force RF-3. Due to the shift down, the drive force (acceleration) of the battery electric vehicle 100 stagnates. Between time t1 and time t2, the deviation occurs between the drive force of the battery electric vehicle 100 and the on-demand target drive force OF. In other words, the deviation occurs between the acceleration of the battery electric vehicle 100 and the virtual acceleration VA. In a case where the shift down of the gear stage that does not appear in the operation of the target virtual mobility occurs as described above, the reproducibility of the acceleration characteristic VC of the target virtual mobility may deteriorate.

Therefore, the on-demand target gear stage calculation unit 133 according to the present embodiment executes processing such that the above problem can be coped with, and calculates the on-demand target gear stage OG. More specifically, the on-demand target gear stage calculation unit 133 calculates the on-demand target gear stage OG such that the gear stage of the transmission 18 is shifted down at the specified timing when the maximum target drive force TFm is greater than the maximum realizable drive force RF. The processing executed by the on-demand target gear stage calculation unit 133 will be described in detail below.

### 4.2. Processing of On-Demand Target Gear Stage Calculation Unit

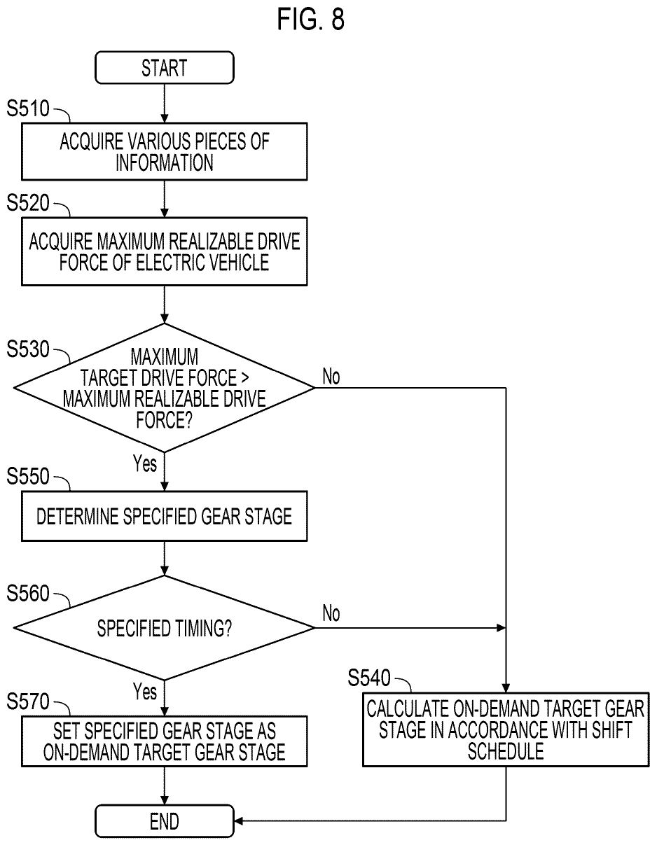

FIG. 8 is a flowchart showing a processing flow of processing executed by the on-demand target gear stage calculation unit 133 (more specifically, the processor 102). The processing flow shown in FIG. 8 is repeatedly executed in a predetermined processing cycle.

In S510, the on-demand target gear stage calculation unit 133 acquires various pieces of information. At least, the on-demand target gear stage calculation unit 133 acquires information on the current vehicle speed Va of the battery electric vehicle 100, the current gear stage of the transmission 18, and the maximum target drive force TFm.

Next, in S520, the on-demand target gear stage calculation unit 133 acquires the current vehicle speed Va of the battery electric vehicle 100 and the maximum realizable drive force RF at the current gear stage of the transmission 18. The maximum realizable drive force RF can be acquired from the output characteristic MF of the battery electric vehicle 100 and the use range RU of each of the gear stages. For example, in FIG. 4, the maximum realizable drive force RF-2, RF-3 are shown for each of the current gear stages of the transmission 18 of 2nd and 3rd. The output characteristic MF of the battery electric vehicle 100 and the use range RU of each of the gear stages may be managed in advance by the computer program 104. The on-demand target gear stage calculation unit 133 refers to the output characteristic MF and the use range RU corresponding to the current gear stage of the transmission 18. As a result, the maximum realizable drive force RF can be acquired from the current vehicle speed Va of the battery electric vehicle 100.

Next, in S530, the on-demand target gear stage calculation unit 133 determines whether the maximum target drive force TFm is greater than the maximum realizable drive force RF. When the maximum target drive force TFm is equal to or smaller than the maximum realizable drive force RF (S530; No), the on-demand target gear stage calculation unit 133 calculates the on-demand target gear stage OG in accordance with the shift schedule as in the normal mode (S540). When the maximum target drive force TFm is equal to or smaller than the maximum realizable drive force RF, the problem does not occur as described above even though the gear stage of the transmission 18 is not shifted down. On the other hand, in a case where the maximum target drive force TFm is greater than the maximum realizable drive force RF (S530; Yes), the processing proceeds to S550.

In S550, the on-demand target gear stage calculation unit 133 determines the gear stage (the specified gear stage) of the transmission 18 that is the shift down destination. For example, the on-demand target gear stage calculation unit 133 specifies a gear stage at which the maximum realizable drive force RF is equal to or greater than the maximum target drive force TFm as a specified gear stage. In this case, the on-demand target gear stage calculation unit 133 sequentially may acquire the maximum realizable drive force RF at each of the gear stages from the current gear stage toward the low-speed side gear stage, and the gear stage at which the acquired maximum realizable drive force RF becomes equal to or greater than the maximum target drive force TFm may be specified as the specified gear stage. Alternatively, the on-demand target gear stage calculation unit 133 may specify the gear stage having the maximum gear ratio as the specified gear stage. That is, in this case, the on-demand target gear stage calculation unit 133 specifies the gear stage at which the maximum realizable drive force RF becomes the largest as the specified gear stage.

After S550, in S560, the on-demand target gear stage calculation unit 133 determines whether the timing is the timing to shift the gear stage of the transmission 18 down (specified timing). The specified timing is set to a timing before the on-demand target drive force OF exceeds the maximum realizable drive force RF. Specific examples of the specified timing include the following.

A first specific example relates to a case where the target virtual mobility is the virtual mobility having the gear-shifting function. The specified timing according to the first specific example is when the target virtual mobility is shifted down. The target virtual mobility is considered to be shifted down before the on-demand target drive force OF (or the virtual acceleration VA) increases significantly in a case where the target virtual mobility is the virtual mobility having the gear-shifting function. Therefore, when the target virtual mobility is shifted down, it can be said that the on-demand target drive force OF is at a timing before exceeding the maximum realizable drive force RF. Further, according to the first specific example, the gear stage of the transmission 18 is shifted down at the same timing as the shift down of the target virtual mobility. As a result, the timing of the gear shift shock due to the shift down can also be matched, such that the reproducibility of the acceleration characteristic VC of the target virtual mobility can be further improved. The on-demand target gear stage calculation unit 133 can determine when the target virtual mobility is shifted down by comparing the current gear stage of the target virtual mobility acquired from the target on-demand model and the target gear stage.

A second specific example relates to an operation state of an accelerator pedal 22 that is an accelerator operation device. The specified timing according to the second specific example is when a specific operation for significantly changing the operation state of the accelerator pedal 22 is performed. It is considered that the operation state of the accelerator pedal 22 is greatly changed before the on-demand target drive force OF (or the virtual acceleration VA) is greatly increased. Therefore, when the operation having the characteristic of largely changing the operation state of the accelerator pedal 22 is performed, it can be said that the on-demand target drive force OF is at a timing before exceeding the maximum realizable drive force RF. The specific operation is, for example, an operation in which the increase amount of the accelerator operation amount is equal to or greater than a threshold value. In addition, for example, the specific operation is an operation in which the accelerator operation amount is 100%. The specific operation may be managed in advance by the computer program 104. The on-demand target gear stage calculation unit 133 can determine that the specific operation is performed by acquiring the operation state of the accelerator pedal 22.

As another specific example, the specified timing may be a time when a predicted value of the on-demand target drive force OF after a certain time exceeds the maximum realizable drive force RF. The predicted value of the on-demand target drive force OF can be acquired from the simulation of the driving environment of the target virtual mobility by the target on-demand model.

In this way, the specified timing is set in the present embodiment. The specified timing may be set in combination with the specific example described above.

When a determination is made that the specified timing is not reached (S560; No), the on-demand target gear stage calculation unit 133 calculates the on-demand target gear stage OG in accordance with the shift schedule as in the normal mode (S540). On the other hand, when a determination is made that the timing is the specified timing (S560; Yes), the on-demand target gear stage calculation unit 133 sets the specified gear stage as the on-demand target gear stage OG.

As described above, the on-demand target gear stage calculation unit 133 according to the present embodiment executes the processing. According to the present embodiment, when the maximum target drive force TFm is greater than the maximum realizable drive force RF, the gear stage of the transmission 18 is shifted down to the specified gear stage at the specified timing before the on-demand target drive force OF exceeds the maximum realizable drive force RF. As a result, it is possible to inhibit the shift down of the gear stage that does not appear in an operation of the target virtual mobility, by the driving operation of the driver. As a result, the reproducibility of the acceleration characteristic VC of the target virtual mobility can be improved.

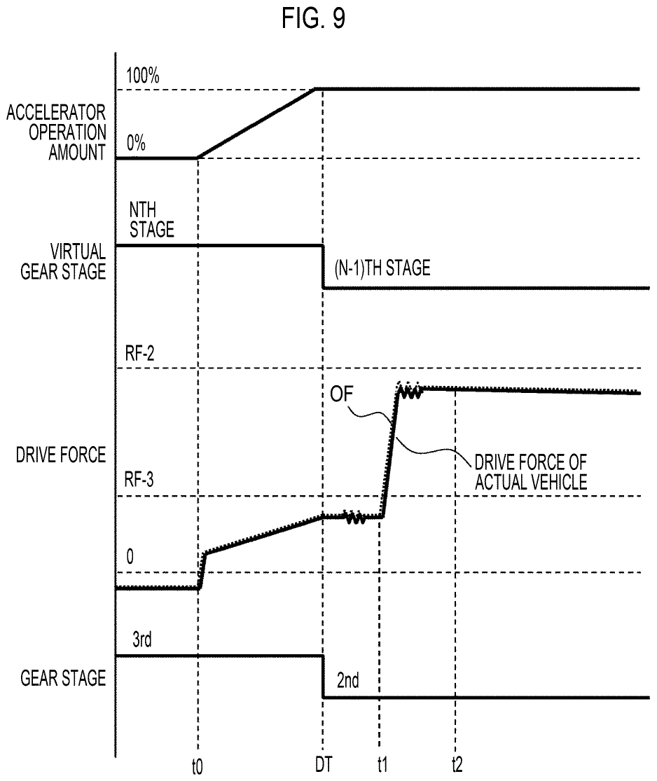

FIG. 9 is a diagram showing an embodiment of the drive control device 101a according to the present embodiment. FIG. 9 shows the same situation as the situation shown in FIG. 7. That is, the example shown in FIG. 9 shows a case where the driver performs the kick down at time to. In FIG. 9, the time change in the virtual gear stage of the target virtual mobility is further shown compared to the case shown in FIG. 7. That is, in the example shown in FIG. 9, the target virtual mobility is the virtual mobility having the gear-shifting function. In FIG. 9, it can be seen that the shift down of the gear stage is performed at the specified timing DT before time t1 when the target virtual mobility is shifted down (from the Nth gear to the (N−1)th gear) as compared with the case shown in FIG. 7. As a result, the gear stage is already the 3rd gear stage at time t1 when the on-demand target drive force OF is greatly increased. Therefore, the drive force (acceleration) of the battery electric vehicle 100 does not stagnate between time t1 and time t2. As a result, the deviation between the drive force of the battery electric vehicle 100 and the on-demand target drive force OF is hardly generated. As described above, according to the present embodiment, the reproducibility of the acceleration characteristic VC of the target virtual mobility can be improved.

In the processing related to S530 of the above-described processing flow, the on-demand target gear stage calculation unit 133 may be configured to determine whether the value obtained by adding the predetermined margin to the maximum target drive force TFm is larger than the maximum realizable drive force RF. As a result, it is possible to make a determination on the shift down to the specified gear stage at a stage where there is a margin.

### 4.3. Configuration Example of On-Demand Model

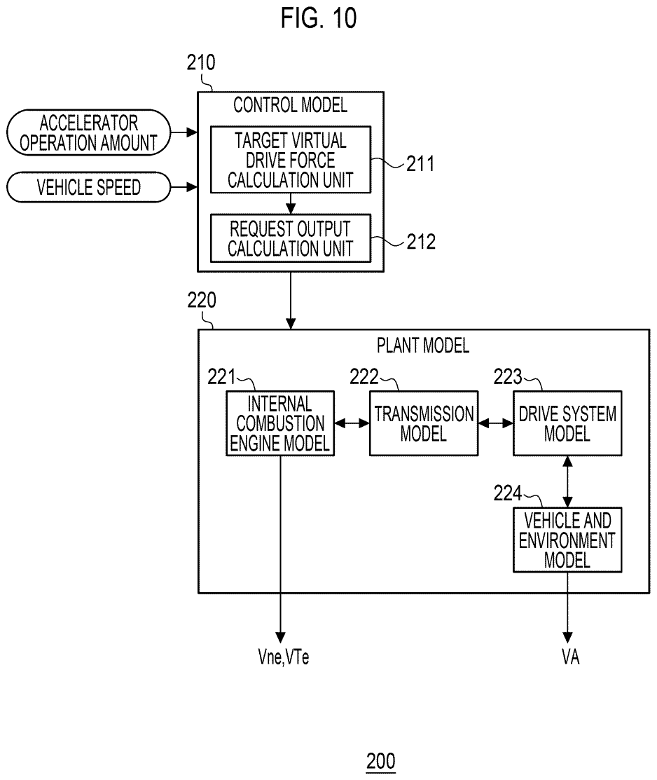

Hereinafter, an example of the configuration of the on-demand model 200 managed by the on-demand model database D10 will be described. FIG. 10 is a diagram showing an example of the configuration of the on-demand model 200. The on-demand model 200 includes a control model 210 and a plant model 220. The control model 210 simulates a control system related to a powertrain of the virtual mobility. The plant model 220 simulates the acceleration and deceleration operation of the virtual mobility in response to the control signal from the control model 210. The plant model 220 includes a model of a powertrain that operates based on a control signal from the control model 210, and a model for simulating the operation of virtual mobility due to the action of the virtual drive force of the powertrain model. The control model 210 can also simulate a control system that calculates a request output for the powertrain of the virtual mobility. Further, the plant model 220 may also simulate a physical constraint on the request output for the powertrain.

The specifications of the control model 210 and the plant model 220 may be different for each type of the powertrain system. For example, configurations of the control system, a transmission, and a drive system are different between the CONV and the HEV. Therefore, in the on-demand model 200 of the CONV and the on-demand model 200 of the HEV, both the control model 210 and the plant model 220 have different specifications, respectively. The example shown in FIG. 10 particularly shows a case where the virtual mobility is an automatic transmission vehicle (AT vehicle) including an internal combustion engine.

The control model 210 includes a target virtual drive force calculation unit 211 and a request output calculation unit 212. The target virtual drive force calculation unit 211 calculates a virtual drive force (target virtual drive force) requested for the powertrain of the virtual mobility based on the accelerator operation amount and the vehicle speed. For example, the target virtual drive force calculation unit 211 performs the calculation using a map in which the target virtual drive force is provided for a combination of the accelerator operation amount and the vehicle speed. The request output calculation unit 212 calculates the request output for the powertrain such that the calculated target virtual drive force can be satisfied. The calculated request output includes a target engine torque of the internal combustion engine or a target gear stage of the transmission. The control model 210 transmits the calculated request output to the plant model 220.

The plant model 220 includes an internal combustion engine model 221, a transmission model 222, a drive system model 223, and a vehicle and environment model 224. The internal combustion engine model 221, the transmission model 222, and the drive system model 223 are models of the powertrain from the drive source to the drive wheels. The vehicle and environment model 224 is a model for simulating the operation of the virtual mobility due to the action of the virtual drive force of the powertrain model.

The internal combustion engine model 221 is a model of an internal combustion engine of the virtual mobility. The internal combustion engine model 221 simulates, for example, the operation of the internal combustion engine in response to an input of the target engine torque. The internal combustion engine model 221 outputs a virtual engine rotation speed VNe and a virtual engine torque VTe. The parameter 201 that can be changed according to the target virtual mobility in the internal combustion engine model 221 is, for example, the engine maximum torque and the engine torque responsiveness.

The transmission model 222 is a model of a transmission of virtual mobility. The transmission model 222 simulates, for example, the operation of the transmission in response to an input of the target gear stage. The transmission model 222 outputs the virtual transmission output torque from the gear ratio determined by the virtual engine torque VTe and the virtual gear stage output by the internal combustion engine model 221. The transmission model 222 includes a stepped transmission model that simulates a stepped transmission and a continuously variable transmission model that simulates a continuously variable transmission. Either the stepped transmission model or the continuously variable transmission model is selected in response to the target virtual mobility. The parameters 201 that can be changed in accordance with the target virtual mobility in the transmission model 222 are, for example, the gear ratio and the shift schedule. In the case of the stepped transmission model, the gear ratio means the gear ratio of each of the gear stages.

The drive system model 223 is a model of a drive system of virtual mobility. In the drive system model 223, for example, a mechanical structure from the transmission to the drive wheels is modeled. The drive system model 223 calculates a drive wheel torque by using the virtual transmission output torque output by the transmission model 222 and a predetermined reduction ratio, and outputs the virtual drive force of the virtual mobility. The parameter 201 that can be changed according to the target virtual mobility in the drive system model 223 is, for example, a reduction ratio and a maximum allowable torque of the propeller shaft.

The vehicle and environment model 224 is a model representing the mechanical characteristics of the virtual mobility and the traveling environment of the virtual mobility. The vehicle and environment model 224 calculates traveling resistance for the virtual mobility from the traveling environment of the virtual mobility. The vehicle and environment model 224 simulates the acceleration and deceleration operation of the virtual mobility from the virtual drive force output from the drive system model 223, the calculated traveling resistance, and the mechanical characteristics of the virtual mobility. The vehicle and environment model 224 outputs the virtual acceleration VA from the acceleration and deceleration operation of the virtual mobility. The parameters 201 that can be changed according to the target virtual mobility in the vehicle and environment model 224 are, for example, weight, wheel diameter, and a CD value.

As described above, the on-demand model 200 can be configured. The on-demand model 200 shown in FIG. 10 is an example. The on-demand model 200 can also be composed of more detailed portions of the model according to the event to be emphasized. For example, a case in which a shock or a response accompanying shifts in a gear and a clutch of a transmission at a time of kick down is to be emphasized is considered. In this case, the transmission model 222 may be configured to finely reproduce a gear mechanism, such as planetary and Ravigneaux, of the transmission, inertia of each component, a change in a transmission path due to engagement and disengagement of the clutch, and the like. On the other hand, in a case where the calculation load in the on-demand model 200 is desired to be reduced, the transmission model 222 may be simply configured to reproduce only the gear ratio.

### 4.4. Modification of On-Demand Target Drive Force Calculation Unit

The on-demand target drive force calculation unit 132 may adopt Modification described below. In the following description, the content of the same parts as the above content will be appropriately omitted.

As described above, according to the present embodiment, the gear stage of the transmission 18 is shifted down to the specified gear stage when the maximum target drive force TFm is greater than the maximum realizable drive force RF, whereby the reproducibility of the acceleration characteristic VC of the target virtual mobility is improved. On the other hand, even in a state where the gear stage of the transmission 18 is shifted down to the specified gear stage, there is a difference between the virtual drive force of the target virtual mobility and the drive force of the battery electric vehicle 100. Therefore, the reproducibility of the acceleration characteristic VC of the target virtual mobility may be reduced. Therefore, in order to solve the problem, the on-demand target drive force calculation unit 132 may be configured to add an additional amount to the on-demand target drive force OF when the gear stage of the transmission 18 is the specified gear stage. The additional amount is a difference obtained by subtracting the current drive force of the battery electric vehicle 100 from the virtual drive force of the target virtual mobility.

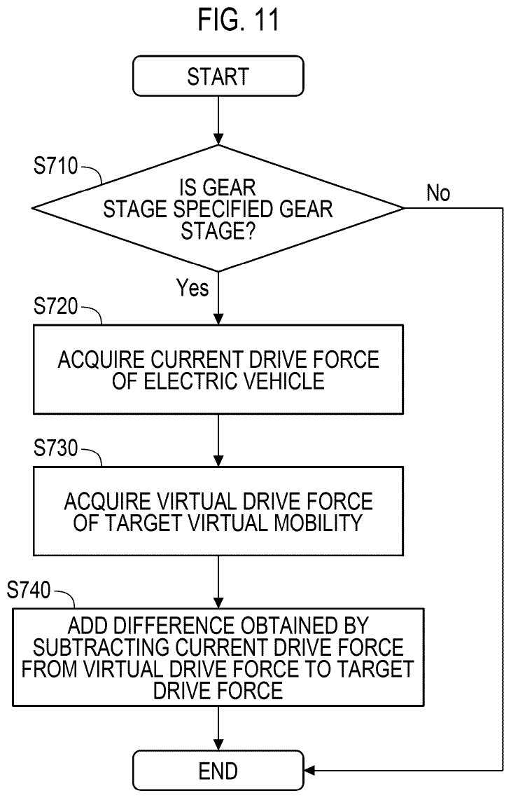

FIG. 11 is a flowchart showing a processing flow of processing executed by the on-demand target drive force calculation unit 132 (more specifically, the processor 102) according to Modification. The processing flow shown in FIG. 11 is repeatedly executed in a predetermined processing cycle.

In S710, the on-demand target drive force calculation unit 132 determines whether the gear stage of the transmission 18 is the specified gear stage. When the gear stage of the transmission 18 is not the specified gear stage (S710; No), the on-demand target drive force calculation unit 132 ends the current processing without correcting the on-demand target drive force OF. When the gear stage of the transmission 18 is the specified gear stage (S710; Yes), the processing proceeds to S720.

In S720, the on-demand target drive force calculation unit 132 acquires the current drive force of the battery electric vehicle 100. For example, the on-demand target drive force calculation unit 132 can acquire the current drive force from the current acceleration of the battery electric vehicle 100.

Next, in S730, the on-demand target drive force calculation unit 132 acquires the virtual drive force of the target virtual mobility. The on-demand target drive force calculation unit 132 can acquire the virtual drive force of the target virtual mobility from the virtual driving environment calculation unit 131.

Next, in S740, the on-demand target drive force calculation unit 132 adds a difference obtained by subtracting the current drive force of the battery electric vehicle 100 from the virtual drive force of the target virtual mobility to the on-demand target drive force OF. After S740, the current processing ends.

According to Modification, the difference obtained by subtracting the current drive force of the battery electric vehicle 100 from the virtual drive force of the target virtual mobility is added to the on-demand target drive force OF. As a result, the difference between the virtual drive force of the target virtual mobility and the drive force of the battery electric vehicle 100 can be reduced. As a result, the reproducibility of the acceleration characteristic VC of the target virtual mobility can be further improved.

The above-described processing flow can also be executed by the mediation unit 140. In this case, the mediation unit 140 executes the above-described processing flow in the case where the battery electric vehicle 100 is in the on-demand mode in the processing 141. In S740, the mediation unit 140 may add a difference obtained by subtracting the current drive force of the battery electric vehicle 100 from the virtual drive force of the target virtual mobility to the target drive force TF.

### 5. In-Vehicle Apparatus Control Device

The control device 101 according to the present embodiment functions as an in-vehicle apparatus control device that controls the speaker 21 and the instrument 23. Specifically, the processor 102 functions as the in-vehicle apparatus control device by executing the computer program 104 for in-vehicle apparatus control stored in the storage device 103. In particular, the in-vehicle apparatus control device controls the speaker 21 or the instrument 23 according to the driving environment of the target virtual mobility when the battery electric vehicle 100 is in the on-demand mode. Hereinafter, the control of the battery electric vehicle 100 by the in-vehicle apparatus control device when the battery electric vehicle 100 is in the on-demand mode will be described.

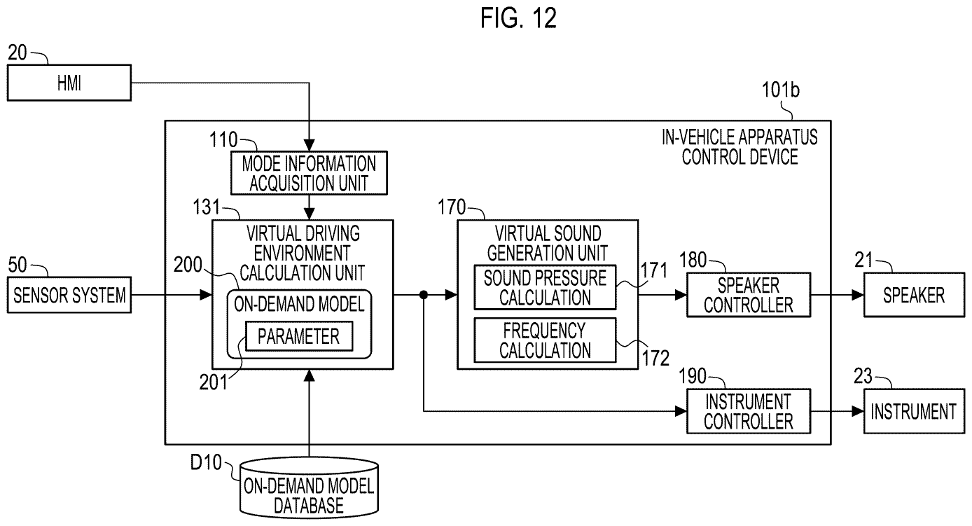

FIG. 12 is a diagram showing an example of a functional configuration of the in-vehicle apparatus control device 101b. The in-vehicle apparatus control device 101b controls the speaker 21 or the instrument 23 according to the driving environment of the target virtual mobility when the battery electric vehicle 100 is in the on-demand mode.

The signals from the HMI 20 and the sensor system 50 are input to the in-vehicle apparatus control device 101b. The signal input from the HMI 20 to the in-vehicle apparatus control device 101b includes a signal indicating the control mode selected by the driver and a signal indicating the target virtual mobility selected by the driver. The signals input from the sensor system 50 to the in-vehicle apparatus control device 101b include a signal indicating the vehicle speed of the battery electric vehicle 100 and a signal indicating the operation state of the accelerator pedal 22. In addition, the signals input from the sensor system 50 to the in-vehicle apparatus control device 101b include a signal indicating an operation state of the brake pedal 24, a signal indicating a rotation speed of the electric motor 2, and a signal indicating a state of charge (SOC) of the battery 14.

The in-vehicle apparatus control device 101b includes a mode information acquisition unit 110, a virtual driving environment calculation unit 131, a virtual sound generation unit 170, a speaker controller 180, and an instrument controller 190 as functional blocks. These functional blocks are realized by the cooperation of the processor 102 that executes the computer program 104 and the storage device 103. The mode information acquisition unit 110 may be the same as that described in FIG. 3. The virtual driving environment calculation unit 131 may be the same as that described in FIG. 6.

The virtual sound generation unit 170 generates the virtual sound that should be heard by the driver in the target virtual mobility in response to the driving operation of the driver. The virtual sound is, for example, an engine sound (pseudo engine sound) generated by an internal combustion engine of the target virtual mobility when the target virtual mobility is a vehicle (engine vehicle) including an internal combustion engine. In addition, for example, the virtual sound is a sound of a drive system of the target virtual mobility. The virtual sound generation unit 170 acquires a sound source of the virtual sound related to the target virtual mobility with reference to the storage device 103. The storage device 103 may store a sound source of a virtual sound for each of the target virtual mobilities. In addition, the virtual sound generation unit 170 acquires information needed to generate the virtual sound from the virtual driving environment calculation unit 131. For example, when the virtual sound is the pseudo engine sound, the virtual sound generation unit 170 acquires the virtual engine rotation speed VNe and the virtual engine torque VTe from the virtual driving environment calculation unit 131. The virtual sound generation unit 170 generates the virtual sound based on the information acquired from the sound source and the virtual driving environment calculation unit 131.

The virtual sound generation unit 170 executes processing 171 of calculating the sound pressure of the virtual sound and processing 172 of calculating the frequency of the virtual loss. For example, when the virtual sound is the pseudo engine sound, in the processing 171, the sound pressure of the pseudo engine sound is calculated from the virtual engine torque VTe using the sound pressure map. The sound pressure map is typically created such that the larger the virtual engine torque VTe is, the larger the sound pressure is. In addition, in the processing 172, the frequency of the virtual sound is calculated from the virtual engine rotation speed VNe using the frequency map. The frequency map is typically created such that the higher the virtual engine rotation speed VNe is, the higher the frequency is. The virtual sound generation unit 170 transmits the generated sound data of the virtual sound to the speaker controller 180.

The speaker controller 180 controls the output of the speaker 21 based on the sound data transmitted from the virtual sound generation unit 170. As a result, the virtual sound is output from the speaker 21.

The instrument controller 190 controls the instrument 23 to display information (hereinafter, referred to as “virtual display information”) to be displayed to the driver in the target virtual mobility in response to the driving operation of the driver. The virtual display information is, for example, virtual engine rotation speed VNe or virtual gear stage of the target virtual mobility when the target virtual mobility is the engine vehicle. The instrument controller 190 acquires the information related to the virtual display information from the virtual driving environment calculation unit 131. For example, when the target virtual mobility is the engine vehicle, the instrument controller 190 acquires the virtual engine rotation speed VNe and the virtual gear stage from the virtual driving environment calculation unit 131. The instrument controller 190 controls the display of the instrument 23 based on the acquired information. As a result, the virtual display information is displayed on the instrument 23.

As described above, with the in-vehicle apparatus control device 101b, in a case where the battery electric vehicle 100 is in the on-demand mode, the virtual sound is output from the speaker 21, and the virtual display information is displayed on the instrument 23. As a result, it is possible to further give the driver a sense of reality as the driver is driving the target virtual mobility.

### 6. Others

The technical features according to the present embodiment can be widely applied to a battery electric vehicle having an electric motor as a drive source, not limited to a BEV. For example, the technical features according to the present embodiment can be applied to an HEV or a PHEV having a mode of traveling solely by a drive force of an electric motor. In addition, the technical features can also be applied to an FCEV that supplies electric energy generated by a fuel cell to an electric motor.

What is claimed is:

1. A battery electric vehicle including an electric motor as a drive source, the battery electric vehicle comprising:
a driving operation member used for driving;
a transmission configured to change an output of the electric motor depending on a gear stage and transmit the changed output to drive wheels of the battery electric vehicle;
one or more storage devices configured to manage a plurality of on-demand models that models a plurality of virtual mobilities with different driving environment characteristics for a driving operation of a driver; and
one or more processors configured to control the output of the electric motor and the gear stage of the transmission,
wherein the one or more processors are configured to, when the battery electric vehicle is in an on-demand mode,
acquire, from the one or more storage devices, a target on-demand model corresponding to a target virtual mobility selected from among the virtual mobilities,
calculate, based on an operation state of the driving operation member and a traveling state of the battery electric vehicle, using the target on-demand model, virtual acceleration of the target virtual mobility for the driving operation of the driver,
calculate a target drive force of the battery electric vehicle for setting acceleration of the battery electric vehicle to be the virtual acceleration,
control the output of the electric motor such that the target drive force is given to the battery electric vehicle,
acquire a maximum target drive force that is a maximum value of the target drive force acquirable at a current vehicle speed of the battery electric vehicle,
acquire a maximum realizable drive force that is a maximum value of a drive force outputtable by the battery electric vehicle at the current vehicle speed of the battery electric vehicle and a current gear stage of the transmission, and
shift down the gear stage of the transmission to a specified gear stage at a specified timing when the maximum target drive force is greater than the maximum realizable drive force.

2. The battery electric vehicle according to claim 1, wherein the specified gear stage is the gear stage at which the maximum realizable drive force is equal to or greater than the maximum target drive force or the gear stage at which a gear ratio is maximized.

3. The battery electric vehicle according to claim 1, wherein, in a case where the target virtual mobility is a virtual mobility with a gear-shifting function, the specified timing is when the target virtual mobility is shifted down.

4. The battery electric vehicle according to claim 1, wherein:
the driving operation member includes an accelerator operation device; and
the specified timing is when a specific operation that significantly changes the operation state of the accelerator operation device is performed.

5. The battery electric vehicle according to claim 1,
wherein the one or more processors are further configured to, when the battery electric vehicle is in the on-demand mode and when the gear stage of the transmission is the specified gear stage,
acquire a current drive force of the battery electric vehicle,
acquire, using the target on-demand model, a virtual drive force of the target virtual mobility for the driving operation of the driver, and
add, to the target drive force, a difference obtained by subtracting the current drive force from the virtual drive force.
